(19) United States
(12) Patent Application Publication
(10) Pub. No.: US 2015/0330541 A1
(43) Pub. Date: Nov. 19, 2015

(54) PROCESS OF MAKING A PLUMBING FITTING, AND THE PRODUCT THEREOF

(71) Applicant: Ayrlett LLC, Nampa, ID (US)

(72) Inventor: Daniel L. McCoy, Nampa, ID (US)

(21) Appl. No.: 14/713,974

(22) Filed: May 15, 2015

Related U.S. Application Data
(60) Provisional application No. 61/993,878, filed on May 15, 2014.

(51) Int. Cl. F16L 13/02; F16L 21/035

(52) U.S. Cl. CPC F16L 13/0209; F16L 21/035

(57) ABSTRACT

A component part formed from a base part and a substrate part formed of materials not compatible for purposes of being welded together, wherein a material that is compatible for purposes of being welded together is overmolded onto a portion of the substrate part before the base part and the substrate part are welded together.

### TECHNICAL FIELD

The disclosure generally relates to the field of connections for pipe-fittings. Particular embodiments relate to joining incompatible parts to form plumbing fittings.

### SUMMARY OF THE DISCLOSURE

Several exemplary processes of making a plumbing fitting and the products thereof are described herein. Of these exemplary processes, included is a first exemplary process which comprises a process of joining two parts together to form a component part, namely a substrate part and a base part, where the substrate part and the base part comprise polymer materials not compatible for purposes of being spin-welded together. The process including the step of overmolding an overmold material (which is compatible for purposes of being spin-welded to the base part) onto the substrate part. Upon overmolding the overmold material onto the substrate part, the substrate part and the base part can be spin-welded together to form a component part.

Another exemplary process comprises a process of joining two parts together to form a component part, namely a substrate part and a base part, where the substrate part and the base part comprise polymer materials not compatible for purposes of being solvent-welded together. The process including the step of overmolding an overmold material (which is compatible for purposes of being solvent-welded to the base part) onto the substrate part. Upon overmolding the overmold material onto the substrate part, the substrate part and the base part can be solvent-welded together to form a component part.

### BRIEF DESCRIPTION OF THE DRAWINGS

FIG. 1 is a first flowchart illustrating the steps in a first exemplary method for making a plumbing fitting.

FIG. 2 is a right side perspective view of a first exemplary component part.

FIG. 3 is right side perspective view of a first exemplary substrate part.

FIG. 4 is a right side perspective view of a first exemplary substrate part and o-ring.

FIG. 5 is a right side perspective view of a first exemplary substrate part with an overmolded portion.

FIG. 6 is a right side perspective view of a first exemplary overmolded portion of the substrate part in position to be spin-welded to the base part.

FIG. 7 is a right side perspective view of a first exemplary overmolded portion of the substrate part spin-welded to the base part, forming a component part.

### DETAILED DESCRIPTION

The following description provides examples of that which the inventor regards as his invention. As such, the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

The use of “e.g.,” “etc,” “for instance,” “in example,” “for example,” and “or” and grammatically related terms indicates non-exclusive alternatives without limitation, unless otherwise noted. The use of “including” and grammatically related terms means “including, but not limited to,” unless otherwise noted. The use of the articles “a,” “an” and “the” are meant to be interpreted as referring to the singular as well as the plural, unless the context clearly dictates otherwise. Thus, for example, reference to “a polymer” includes two or more such polymers, and the like. The use of “optionally,” “alternatively,” and grammatically related terms means that the subsequently described element, event or circumstance may or may not be present/occur, and that the description includes instances where said element, event or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary” means “an example of” and is not intended to convey a meaning of an ideal or preferred embodiment.

As used herein, the term “part” means a piece or segment of an object, unless the context clearly indicates otherwise.

As used herein, the term “overmolding,” and the like, means molding one part (the “overmold”) over or onto an already formed part (the “substrate part”), and curing the overmold in contact with the substrate part so as to bond the overmold to the substrate part to form an overmolded portion, unless the context clearly indicates otherwise.

As used herein, the term “substrate part” refers to the formed part that an overmold is overmolded onto during an overmolding process, unless the context clearly indicates otherwise. Examples of substrate parts include, but are not limited to, plumbing fittings having an existing connector extending therefrom (e.g., connectors, threaded couplings, barb clamp fittings, solvent-welding fittings, quick connect fittings, crimped fittings, pressed fittings, elbows, couplings, unions, reducers, Olets, tees, cross, caps, plugs, nipples, barbs, valves). A substrate part can comprise any material, including but not limited to polymers, composites, and metals (e.g., brass).

As used herein, the terms “overmold” and “overmold material” refer to a polymer material that is overmolded onto the substrate part during an overmolding process, unless the context clearly indicates otherwise. Overmolding is generally conducted by injecting an overmold material into a cavity and around an insert piece (such as a substrate part) inserted into the same cavity. The end-result is a single part, as the overmold material and insert piece generally fuse together.

As used herein, the term “overmolded portion” refers to the formed part during an overmolding process. Thus, an overmolded portion is a combination of a substrate part and overmold material, unless the context clearly indicates otherwise. Examples of overmolded portions include, but are not limited to, plumbing fittings overmolded with a polymer material and polyphenylsulfone couplings overmolded with a polymer material.

As used herein, the term “base part” refers to the part in which an overmolded portion of a substrate part is welded to, unless the context clearly indicates otherwise. Examples of base parts include, but are not limited to, polymer plumbing fittings.

As used herein, the term “component part” refers to the component formed by spin-welding, solvent-welding, or otherwise joining an overmolded portion to a base part, unless the context clearly indicates otherwise. A component part can be used as a plumbing fitting (a “plumbing component part”).

As used herein, the term “compatible for purposes of being spin-welded together” means polymer materials that upon being spin-welded together form a high strength weld joint, unless the context clearly indicates otherwise.

As used herein, the term “compatible for purposes of being solvent-welded together” means polymer materials that upon being solvent-welded together form a high strength weld joint, unless the context clearly indicates otherwise.

As used herein, the term “spin-welding” means a friction welding technique used on polymer materials, in which parts to be welded together are heated by friction (e.g., heat generated by turning on a lathe, a drill press, or a milling machine, where one part is driven by the chuck, and the other is held stationary with the spinning part driven against it) until the heat of friction between the parts reaches a sufficient level for the parts to weld together, at which time the stationary part is then released to spin as well, while pressure is applied along the axis of rotation, holding the parts together as they cool, unless the context clearly indicates otherwise.

As used herein, the terms “solvent welding” and the like mean a polymer welding process of forming at least a partial seal between a first polymer part and a second polymer part by use of a solvent, unless the context clearly indicates otherwise.

As used herein, the term “plumbing fitting” is used broadly to include not only fittings used in pipe plumbing systems to connect straight pipe or tubing sections, to adapt to different sizes or shapes, and for other purposes, such as regulating or measuring fluid flow, but also for pipe plumbing systems and parts in pipe plumbing systems in general, unless the context clearly indicates otherwise.

As used herein, the term “polymer” and “polymer material” means a material formed by polymerization and comprising repeating units of the same (homopolymer) or different (copolymer) type of monomers, unless the context clearly indicates otherwise. Examples of polymers include, but are not limited to: polyacetal polymers (e.g., acetal, monopolymer acetal, acetal copolymer, polyoxymethylene (POM), polyformaldehyde, DELRIN®, acetal homopolymer), polysulfone (PSU), polyphenylsulfone (PPSU), modified polyphenylsulfone, polybenzimidazole, polyethylene (PE), polypropylene (PP), polytetrafluoroethylene (PTFE), polystyrene (PS), polyvinylidene fluoride (PVDF), polyether ether ketone (PEEK), crosslinked polyethylene (PEX), polyvinyl chloride (PVC), chlorinated polyvinyl chloride (CPVC), acrylonitrile butadiene styrene (ABS), acrylic ((poly(methyl methacrylate) (PMMA)), nylon, thermoplastics, and copolymers of any of them and combinations of any two or more of them.

The present invention comprises exemplary processes of joining two parts together to form a component part, and the product of such processes.

A first exemplary process comprises a process of joining two parts together to form a component part, namely a substrate part and a base part, where the substrate part and the base part comprise polymer materials not compatible for purposes of being spin-welded together. The process including the step of overmolding an overmold material (which is compatible for purposes of being spin-welded to the base part) onto the substrate part. Upon overmolding the overmold material onto the substrate part, the substrate part and the base part can be spin-welded together to form a component part.

A second exemplary process comprises a process of joining two parts together to form a component part configured for use as a plumbing fitting. The two parts being a first plumbing fitting and a second plumbing fitting. In the second exemplary process, the first plumbing fitting is the substrate part and the second plumbing fitting is the base part. The first plumbing fitting and the second plumbing fitting comprise polymer materials that are not compatible for purposes of being spin-welded together. The process including the step of overmolding an overmold material (which is compatible for purposes of being spin-welded to the second plumbing fitting) onto the first plumbing fitting to create an overmolded portion. Upon overmolding the overmold onto the first plumbing fitting, the first plumbing fitting and second plumbing fitting can be spin-welded together to form the component part, a joint plumbing fitting.

A third exemplary process comprises a process of joining two parts together to form a component part configured for use as a plumbing fitting. The two parts being a first plumbing fitting and a second plumbing fitting. In the third exemplary process, the first plumbing fitting is the substrate part and the second plumbing fitting is the base part. In this process, the first plumbing fitting comprises a first polymer material and the second plumbing fitting comprise a second polymer material, and the first and second polymer materials are not compatible for purposes of being spin-welded together.

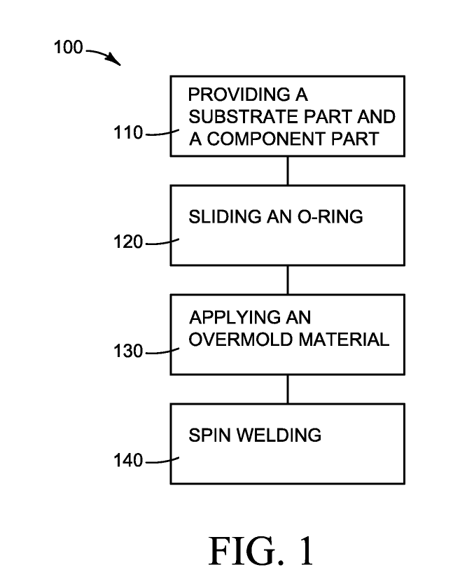

The third exemplary process 100 is illustrated in FIG. 1. At step 110 a substrate part comprised of a first polymer material is provided, and a base part comprised of a second polymer material is provided. The substrate part comprises at least one male portion, and the base part comprises at least one female portion. At step 120, a flexible O-ring is slid over a portion of the substrate part, the O-ring secured by at least one radial channel extending about the substrate part. At step 130 an overmold material is applied about the portion of the substrate part comprised of the O-ring, creating an overmolded portion. The overmold material selected is compatible for purposes of being spin-welded to the base part selected. At step 140 the overmolded portion is spin-welded to the female portion of the base part. The end result of spin-welding the two parts together is a component part.

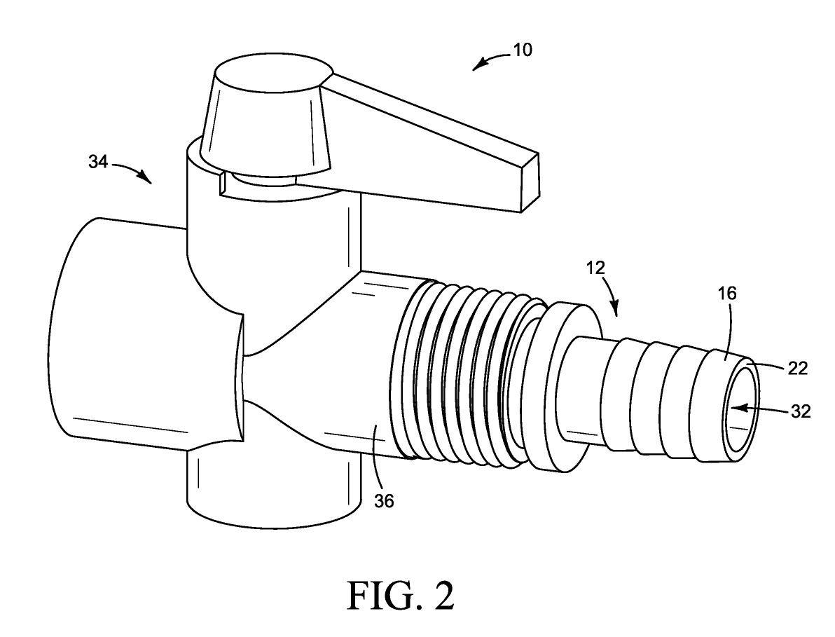

The parts used in the third exemplary process, and the product formed by the third exemplary process, are illustrated in FIGS. 2 through 7. The product comprises a component part 10 (a combined plumbing fitting) created from welding a substrate part 12 (a first plumbing fitting) and base part 34 (a second plumbing fitting) together. In this exemplary process, the substrate part 12 and the base part 34 comprise polymer materials that are not compatible for purposes of being spin-welded together.

FIG. 2 illustrates an exemplary component part 10. The component part 10 comprises a substrate part 12 spin-welded into a base part 34. The substrate part 12 further comprises a first male portion 16 and second male portion 18, the second male portion 18 comprises and overmolded portion 44.

In this illustrated component part 10, the exemplary substrate part 12 illustrated is a plumbing connector. While a plumbing connector is illustrated in this Figure, a skilled artisan will be able to select an appropriate substrate part in a particular embodiment based on various considerations, including the intended use of the component part, the intended arena within which the component part will be used, and the equipment and/or accessories with which the component part is intended to be used, among other considerations.

In this illustrated component part 10, the exemplary base part 34 illustrated is a water supply valve. While a water supply valve is illustrated in this Figure, a skilled artisan will be able to select an appropriate base part in a particular embodiment based on various considerations, including the intended use of the component part, the intended arena within which the component part will be used, and the equipment and/or accessories with which the component part is intended to be used, among other considerations.

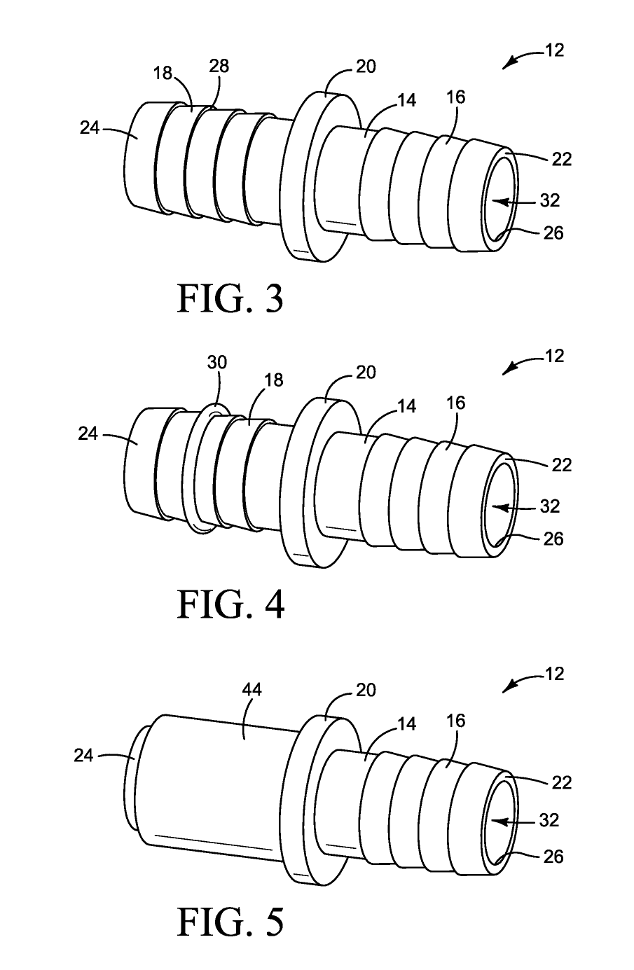

FIG. 3 illustrates the substrate part 12 before it is overmolded and spin-welded to the base part 34 to form the component part 10. The substrate part 12 comprises a body 14 having a first male portion 16, a second male portion 18, and a spacer 20 therebetween. The substrate part 12 having a first end 22 opposite a second end 24. The first end 22 on the first male portion 16. The second end 24 on the second male portion 18. An orifice 26 is defined in the first end 22, and an orifice 27 is defined in the second end 24. The two orifices connected by a passageway 32 extending through the substrate part 12.

Preferably, the substrate part 12 comprises at least one attachment portion. The attachment portion for at least temporarily retaining a sealing portion, such as an O-ring, in place. In these Figures, the attachment portion comprises a radial channel 28 extending about the body 14. FIG. 3 illustrates a radial channel 28 extending about the second male portion 18. The radial channel 28 is configured for receiving an O-ring 30 therein. The radial channel 28 illustrated comprise a barbed surface of the second male portion 18.

Alternatively, the attachment portion could be a notch, groove, or any other manner of at least temporarily holding an O-ring 30. A skilled artisan will be able to select an appropriate attachment portion in a particular embodiment based on various considerations, including the intended use of the component part, the intended arena within which the component part will be used, and the equipment and/or accessories with which the component part is intended to be used, among other considerations. Alternatively, an O-ring 30 can be placed about the first male portion 16 and/or second male portion 18 without the presence of an attachment portion.

At least a portion of the base part 34 comprises a first polymeric material, and at least a portion of the body 14 of the substrate part 12 is made of a second polymer material. The first polymer material is not compatible for purposes of being spin-welded together with the second polymer material.

In the third exemplary process, the substrate part 12 is a first polymer, and the base part 34 comprises a polymer material not compatible for purposes of being spin-welded with the first polymer material. To overcome this incompatibility, a portion of the substrate part 12 can be overmolded with a polymer material that is compatible for purposes of being spin-welded together to with the polymer material of the base part 34. A skilled artisan will be able to select an appropriate material for the base part, the overmold material, and the substrate part in a particular embodiment based on various considerations, including the intended use of the component part, the intended arena within which the component part will be used, and the equipment and/or accessories with which the component part is intended to be used, among other considerations.

Upon overmolding the overmold material to the substrate part 12, the substrate part 12 and the base part 34 can be spin-welded together to form a joint plumbing fitting (the component part 10).

FIG. 4 illustrates the substrate part 12 with an O-ring 30 secured to the second male portion 18, with the O-ring 30 retained in a radial channel 28 (illustrated in FIG. 3) on the body 14. In the exemplary substrate part 12 illustrated in FIGS. 2 through 7, the radial channel 28 circumscribes the body 14. The utilization of such an O-ring 30 is optional, and may or may not be present in an exemplary process or product.

It is preferred that the O-ring 30 have a smaller diameter than that of the second male portion 18 so as to enable a tight fit on the second male portion 18. Preferably, the O-ring 30 comprises an elastomer. A skilled artisan will be able to select an appropriate structure and material for the O-ring in a particular embodiment based on various considerations, including the intended use of the component part, the intended arena within which the component part will be used, and the equipment and/or accessories with which the component part is intended to be used, among other considerations.

To position the O-ring 30 on the second male portion 18, the O-ring 30 can be slid onto the second end 24 of the body 14, over the body 14 of the substrate part 12, and on to the second male portion 18. The O-ring 30 is added to create a greater water-tight seal, should the overmolded portion 44 and the substrate part 12 ever separate. Once the O-ring 30 is positioned, the second male portion 18, including the O-ring 30, is then overmolded with an overmolded portion 44. Upon overmolding the overmolded portion 44 onto the substrate part 12, the substrate part 12 can be spin-welded together with the base part 34 to create the component part 10.

FIG. 5 illustrates the substrate part 12 with the overmolded portion 44 overmolded onto the second male portion 18. In such a configuration, the overmolded portion 44 covers at least a portion of the second male portion 18. The overmolded portion 44 attaches itself to the second male portion 18 in such a manner that it seals itself thereto, and with the aid of the O-ring 30, creates a water-tight seal, particularly when spin-welded to the base part 34.

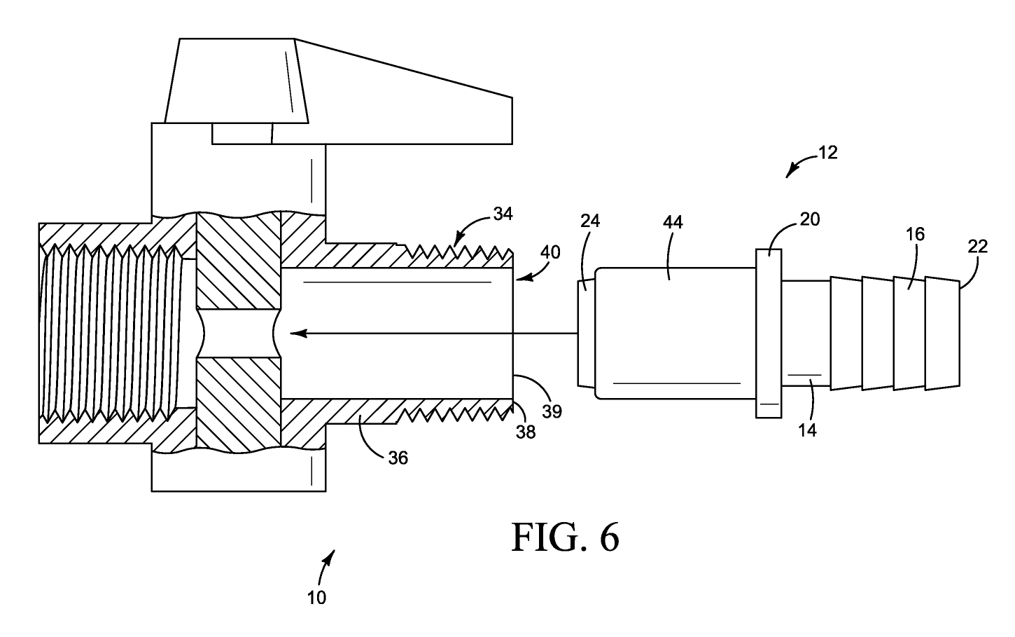

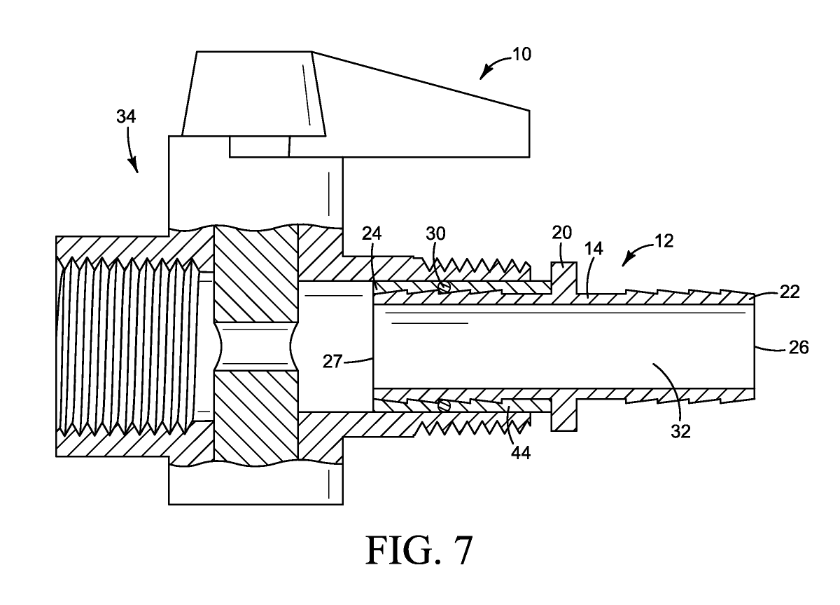

FIG. 6 illustrates the overmolded portion 44 of the substrate part 12 in position to be spin-welded to the base part 34. By spin-welding the substrate part 12 and the base part 34 together, the component part 10 is formed. The base part 34 comprises a body 36 having a first end 38, the first end 38 comprising an orifice 39 connecting with a passageway 40 defined within the body 36, thereby defining a female portion. Preferably, the passageway 40 of the base part 34 comprises an inside diameter generally larger than the outside diameter of the overmolded portion 44 of the second male portion 18. Such a configuration enables the overmolded portion 44 to be spin-welded into the passageway 40. FIG. 7 illustrates the overmolded portion 44 of the substrate part 12 attached to the base part 34 after spin-welding to form the component part 10.

A fourth exemplary process is similar to the third exemplary process above, but as follows. In the fourth exemplary process, the substrate part is a polyphenylsulfone coupling (such as those used in PEX (cross-linked polyethylene) water system connections), and the base part comprises polyacetal polymer water supply valve. Polyacetal polymer is not compatible for purposes of being spin-welded with polyphenylsulfone. In the fourth exemplary process, a polymer material compatible for purposes of being spin-welded to polyacetal polymer could be overmolded onto the polyphenylsulfone substrate part, and then the overmolded substrate part and the base part could be spin-welded together. For instance, the polymer material could be polyacetal polymer, such as DELRIN® brand polyoxymethylene polymer (aka acetal, polyacetal and polyformaldehyde)?

A fifth exemplary process is similar to the third exemplary process above, but as follows. In the fifth exemplary process, the substrate part is a polyphenylsulfone coupling, and the base part comprises a chlorinated polyvinyl chloride water supply valve. Chlorinated polyvinyl chloride is not compatible for purposes of being spin-welded with polyphenylsulfone. In the fifth exemplary process, a polymer material compatible for purposes of being spin-welded to chlorinated polyvinyl chloride polymer could be overmolded onto the polyphenylsulfone substrate part, and then the overmolded substrate part and the base part could be spin-welded together. For instance, the polymer material could be chlorinated polyvinyl chloride polymer, such as FLOWGUARD® or FLOWGUARD GOLD® brand chlorinated polyvinyl chloride polymer.

A sixth exemplary process is similar to the third exemplary process above, but as follows. In the sixth exemplary process, the substrate part is a polysulfone coupling, and the base part comprises a chlorinated polyvinyl chloride water supply valve. Chlorinated polyvinyl chloride is not compatible for purposes of being spin-welded with polysulfone. In the sixth exemplary process, a polymer material compatible for purposes of being spin-welded to chlorinated polyvinyl chloride polymer could be overmolded onto the polysulfone substrate part, and then the overmolded substrate part and the base part could be spin-welded together. For instance, the polymer material could be chlorinated polyvinyl chloride polymer, such as FLOWGUARD® or FLOWGUARD GOLD® brand chlorinated polyvinyl chloride polymer.

A seventh exemplary process is similar to the third exemplary process above, but as follows. In the seventh exemplary process, the substrate part is a polysulfone coupling, and the base part comprises a polyvinyl chloride water supply valve. Polyvinyl chloride is not compatible for purposes of being spin-welded with polysulfone. In the seventh exemplary process, a polymer material compatible for purposes of being spin-welded to polyvinyl chloride polymer could be overmolded onto the polysulfone substrate part, and then the overmolded substrate part and the base part could be spin-welded together. For instance, the polymer material could be chlorinated polyvinyl chloride polymer, such as FLOWGUARD® or FLOWGUARD GOLD® brand chlorinated polyvinyl chloride polymer.

An eighth exemplary process is similar to the third exemplary process above, but as follows. In the eighth exemplary process, the substrate part is a polysulfone coupling, and the base part comprises a polyacetal polymer water supply valve. Polyacetal polymer is not compatible for purposes of being spin-welded with polysulfone. In the eighth exemplary process, a polymer material compatible for purposes of being spin-welded to polyacetal polymer could be overmolded onto the polysulfone substrate part, and then the overmolded substrate part and the base part could be spin-welded together. For instance, the polymer material could be polyacetal polymer, such as DELRIN® brand polyoxymethylene polymer (aka acetal, polyacetal and polyformaldehyde)?

A ninth exemplary process is similar to the third exemplary process above, but as follows. In the ninth exemplary process, the substrate part is a polyphenylsulfone coupling, and the base part comprises a polyvinyl chloride water supply valve. Polyvinyl chloride is not compatible for purposes of being spin-welded with polyphenylsulfone. In the ninth exemplary process, a polymer material compatible for purposes of being spin-welded to polyvinyl chloride polymer could be overmolded onto the polyphenylsulfone substrate part, and then the overmolded substrate part and the base part could be spin-welded together. For instance, the polymer material could be chlorinated polyvinyl chloride polymer, such as FLOWGUARD® or FLOWGUARD GOLD® brand chlorinated polyvinyl chloride polymer.

A tenth exemplary process is similar to the third exemplary process above, but as follows. In the tenth exemplary process, the substrate part is a brass coupling, and the base part comprises a polyvinyl chloride water supply valve. Polyvinyl chloride is not compatible for purposes of being spin-welded with brass. In the tenth exemplary process, a polymer material compatible for purposes of being spin-welded to polyvinyl chloride polymer could be overmolded onto the brass substrate part, and then the overmolded substrate part and the base part could be spin-welded together. For instance, the polymer material could be chlorinated polyvinyl chloride polymer, such as FLOWGUARD® or FLOWGUARD GOLD® brand chlorinated polyvinyl chloride polymer.

An eleventh exemplary process is similar to the third exemplary process above, but as follows. In the eleventh exemplary process, the substrate part is a brass coupling, and the base part comprises a chlorinated polyvinyl chloride water supply valve. Chlorinated polyvinyl chloride is not compatible for purposes of being spin-welded with brass. In the eleventh exemplary process, a polymer material compatible for purposes of being spin-welded to chlorinated polyvinyl chloride polymer could be overmolded onto the brass substrate part, and then the overmolded substrate part and the base part could be spin-welded together. For instance, the polymer material could be chlorinated polyvinyl chloride polymer, such as FLOWGUARD® or FLOWGUARD GOLD® brand chlorinated polyvinyl chloride polymer.

A twelfth exemplary process is similar to the third exemplary process above, but as follows. In the twelfth exemplary process, the substrate part is a brass coupling, and the base part comprises a polyacetal polymer water supply valve. Polyacetal polymer is not compatible for purposes of being spin-welded with brass. In the twelfth exemplary process, a polymer material compatible for purposes of being spin-welded to polyacetal polymer could be overmolded onto the brass substrate part, and then the overmolded substrate part and the base part could be spin-welded together. For instance, the polymer material could be polyacetal polymer, such as DELRIN® brand polyoxymethylene polymer (aka acetal, polyacetal and polyformaldehyde)?

A thirteenth exemplary process is similar to the third exemplary process, except as follows. The thirteenth exemplary process comprises a process of joining a first plumbing fitting and a second plumbing fitting together to form a component part, where the polymer materials of the first plumbing fitting and the second plumbing fitting are not compatible for purposes of being solvent-welded to one another. In the thirteenth exemplary process, the first plumbing fitting is the substrate part, and the second plumbing fitting is the base part. The process includes the step of overmolding an overmold material onto the first plumbing fitting to create an overmolded portion. The overmold material being compatible for purposes of being solvent-welded to the second plumbing fitting. Upon overmolding the overmold material onto the first plumbing fitting, the first plumbing fitting and second plumbing fitting can be solvent-welded together to form a component part, namely a joint plumbing fitting.

The fourteenth exemplary process is similar to the thirteenth exemplary process, but as follows. In the fourteenth exemplary process, the substrate part is a polymer coupling, the base part is a chlorinated polyvinyl chloride plumbing fitting, and the overmold material is chlorinated polyvinyl chloride.

The fifteenth exemplary process is similar to the thirteenth exemplary process, but as follows. In the fifteenth exemplary process, the substrate part is a polymer coupling, the base part is a polyvinyl chloride plumbing fitting, and the overmold material is chlorinated polyvinyl chloride.

The sixteenth exemplary process is similar to the thirteenth exemplary process, but as follows. In the sixteenth exemplary process, the substrate part is a polymer coupling, the base part is a polyvinyl chloride plumbing fitting, and the overmold material is polyvinyl chloride.

The seventeenth exemplary process is similar to the thirteenth exemplary process, but as follows. In the seventeenth exemplary process, the substrate part is a polyphenylsulfone coupling, the base part is a chlorinated polyvinyl chloride plumbing fitting, and the overmold material is chlorinated polyvinyl chloride.

The eighteenth exemplary process is similar to the thirteenth exemplary process, but as follows. In the eighteenth exemplary process, the substrate part is a polyphenylsulfone coupling, the base part is a chlorinated polyvinyl chloride plumbing fitting, and the overmold material is polyvinyl chloride.

The nineteenth exemplary process is similar to the thirteenth exemplary process, but as follows. In the nineteenth exemplary process, the substrate part is a polyphenylsulfone coupling, the base part is a polyvinyl chloride plumbing fitting, and the overmold material is polyvinyl chloride.

The twentieth exemplary process is similar to the thirteenth exemplary process, but as follows. In the twentieth exemplary process, the substrate part is a polyphenylsulfone coupling, the base part is a polyvinyl chloride plumbing fitting, and the overmold material is chlorinated polyvinyl chloride.

In an exemplary spin-welding process, to spin-weld the two components together, a user may select several control parameters that affect weld quality. First, to spin-weld the overmolded portion of the substrate part to the base part, the second male portion of the overmolded portion could be placed up to and adjacent the passageway of the base part. Once done, a skilled artisan could select a fixed rotational speed to drive the overmolded portion and the second male portion into the passageway of the base part. Appropriate factors for a skilled artisan to consider are, but not limited to, material composition and joint geometry. After selecting an appropriate fixed rotational speed, a skilled artisan could select the press speed at which the overmolded portion and the second male portion is driven into the passageway of the base part. This is, essentially, the pressure exerted on the overmolded portion and the second male portion into the passageway of the base part. Appropriate factors for a skilled artisan to consider are, but not limited to, the fixed rotational speed chosen, joint geometry, and material composition. Next, a skilled artisan could select the weld depth to which the second male portion (with overmolded portion) is welded into the base part. Preferably, the weld is deep enough to produce a strong, sealed joint. Appropriate factors for a skilled artisan to consider are, but not limited to, the length of the overmolded portion and second male portion, and the depth of the first passageway. Finally, a skilled artisan could select an appropriate hold time for the newly spin-welded component part to solidify. Due to the molten nature of the material from caused by the frictional forces of driving the overmolded portion and second male portion into the passageway of the base part, the crystal structure of the resulting component part will settle. An appropriate factor for a skilled artisan to consider in selecting an appropriate hold time is, but is not limited to, the sizes of the overmolded portion, second male portion, passageway, and base part being spin-welded together.

While spin-welding and solvent welding are specifically described above, in other exemplary processes, other forms of polymer welding could be utilized to join the substrate part and the base part together, including but not limited to hot gas welding, speed tip welding, extrusion welding, contact welding, hot plate welding, high frequency welding, injection welding, ultrasonic welding, friction welding, and laser welding. A skilled artisan will be able to select an appropriate welding method for welding two parts together in a particular embodiment based on various considerations, including the intended use of the resulting component part, the intended arena within which the component part will be used, and the equipment and/or accessories with which the component part is intended to be used, among other considerations.

A first exemplary product by process is the product created by the first exemplary process above. A second exemplary product by process is the product created by the second exemplary process above. A third exemplary product by process is the product created by the third exemplary process above. A fourth exemplary product by process is the product created by the fourth exemplary process above. A fifth exemplary product by process is the product created by the fifth exemplary process above. A sixth exemplary product by process is the product created by the sixth exemplary process above. A seventh exemplary product by process is the product created by the seventh exemplary process above. An eighth exemplary product by process is the product created by the eighth exemplary process above. A ninth exemplary product by process is the product created by the ninth exemplary process above. A tenth exemplary product by process is the product created by the tenth exemplary process above. An eleventh exemplary product by process is the product created by the eleventh exemplary process above. A twelfth exemplary product by process is the product created by the twelfth exemplary process above. A thirteenth exemplary product by process is the product created by the thirteenth exemplary process above. A fourteenth exemplary product by process is the product created by the fourteenth exemplary process above. A fifteenth exemplary product by process is the product created by the fifteenth exemplary process above.

An exemplary method of creating a component part from a substrate part and a base part comprises the steps of: providing a base part comprising a first polymer material, said base part having a first end; providing a substrate part comprising a second polymer material, said substrate part having a male portion, said male portion comprising at least one radial channel extending thereabout; overmolding an overmold material comprising a third polymer material onto a portion of said substrate part to create an overmolded portion; and spin-welding said overmolded portion to said base part by driving said male portion into said first end and rotating said male portion wherein spin-welding affixes said overmolded portion to said base part, wherein said first polymer material and said second polymer material comprise different materials.

Any suitable structure and/or material can be used for the parts used in an exemplary process, and a skilled artisan will be able to select an appropriate structure and material for the parts in a particular embodiment based on various considerations, including the intended use of the exemplary process, the intended arena within which the products of the exemplary process will be used, and the equipment and/or accessories with which the process and/or products of the process are intended to be used, among other considerations. Materials hereinafter discovered and/or developed that are determined to be suitable for use in exemplary processes would also be considered suitable for use in an exemplary process according to a particular embodiment.

It is noted that all structure and features of the various described and illustrated embodiments can be combined in any suitable configuration for inclusion in an exemplary process according to a particular embodiment. For instance, examples include but are not limited to: the polymer material of the base part could be polyvinyl chloride, the overmold material could be polyacetal, and the substrate part could be polyphenylsulfone.

It is noted that all structure and features of the various described and illustrated embodiments can be combined in any suitable configuration for inclusion in a component part according to a particular embodiment. For example, a component part according a particular embodiment can include the O-ring described above, or such an O-ring may not be included.

The foregoing detailed description provides exemplary embodiments of the invention, and includes the best mode for practicing the invention. The description and illustration of these embodiments is intended only to provide examples of the invention, and not to limit the scope of the invention, or its protection, in any manner.

What is claimed is:

1. A component part, said component part comprising:
a base part comprising a first polymer material; and
a substrate part comprising a second polymer material, wherein at least a portion of said substrate part comprising an overmolded portion, said overmolded portion comprising a third polymer material, wherein said second polymer material and said third polymer material are different polymer materials,
wherein said overmolded portion of said substrate part is spin-welded or solvent-welded to said base part.

2. The component part of claim 1, wherein said substrate part comprises a coupling, wherein said base part is a water supply valve, wherein said first polymer material comprises chlorinated polyvinyl chloride, and wherein said third polymer material comprises chlorinated polyvinyl chloride.

3. The component part of claim 2, wherein said second polymer material comprises polyphenylsulfone.

4. The component part of claim 1, wherein said substrate part comprises a coupling, wherein said base part is a water supply valve, wherein said first polymer material comprises chlorinated polyvinyl chloride, and wherein said third polymer material comprises polyvinyl chloride.

5. The component part of claim 4, wherein said second polymer material comprises polyphenylsulfone.

6. The component part of claim 1, wherein said substrate part comprises a coupling, wherein said base part is a water supply valve, wherein said first polymer material comprises polyvinyl chloride, and wherein said third polymer material comprises polyvinyl chloride.

7. The component part of claim 6, wherein said second polymer material comprises polyphenylsulfone.

8. The component part of claim 1, wherein said substrate part comprises a coupling, wherein said base part is a water supply valve, wherein said first polymer material comprises polyvinyl chloride, and wherein said third polymer material comprises chlorinated polyvinyl chloride.

9. The component part of claim 8, wherein said second polymer material comprises polyphenylsulfone.

10. The component part of claim 1, wherein said substrate part comprises a coupling, wherein said base part is a water supply valve, wherein said first polymer material comprises polyacetal polymer.

11. The component part of claim 10, wherein said second polymer material comprises polyphenylsulfone.

12. The component part of claim 1, wherein said substrate part comprises a coupling, wherein said base part is a water supply valve, wherein said first polymer material comprises polyacetal polymer, and wherein said third polymer material comprises polyacetal polymer.

13. The component part of claim 12, wherein said second polymer material comprises polyphenylsulfone.

14. The component part of claim 1, further comprising at least one O-ring between said overmolded portion and said substrate part onto which said overmolded portion is overmolded.

15. The component part of claim 14, wherein said substrate part further comprises at least one attachment portion configured for receiving at least one O-ring therein, wherein said attachment portion comprises a radial channel.

16. A plumbing component part, said plumbing component part comprising:
a polyphenylsulfone coupling comprising a male portion onto which an O-ring is received, wherein at least a portion of said male portion comprises an overmolded male portion comprising a third polymer material selected from the group consisting of polyacetal polymer, polyvinyl chloride, and chlorinated polyvinyl chloride; and
a water supply valve comprising a female portion, said female portion comprising a second polymer material selected from the group consisting of polyacetal polymer, polyvinyl chloride, and chlorinated polyvinyl chloride,
wherein said overmolded male portion of said polyphenylsulfone coupling is spin-welded or solvent-welded into said female portion of said water supply valve.

17. The plumbing component part of claim 16, wherein said third polymer material comprises polyacetal polymer, and wherein said second polymer material comprises polyacetal polymer.

18. The plumbing component part of claim 16, wherein said third polymer material is selected from the group consisting of polyvinyl chloride, and chlorinated polyvinyl chloride, and wherein the second polymer material is selected from the group consisting of polyvinyl chloride, and chlorinated polyvinyl chloride.

19. A component part, said component part comprising:
a base part comprising a first polymer material; and
a substrate part comprising a metal, wherein at least a portion of said substrate part comprises an overmolded portion, said overmolded portion comprising a second polymer material,
wherein said overmolded portion of said substrate part is spin-welded or solvent-welded to said base part.

20. The component part of claim 19, wherein said overmolded portion comprises an overmold material, and wherein said overmold material and said first polymer material comprise the same polymer material.
